(19) United States
(12) Patent Application Publication
(10) Pub. No.: US 2016/0121977 A1
(43) Pub. Date: May 5, 2016

(54) FLOATATION ACCESSORY DEVICE FOR AN E-READING DEVICE

(71) Applicant: Kobo Inc., Toronto (CA)

(72) Inventor: Mark Lefebvre, Hamilton (CA)

(21) Appl. No.: 14/527,517

(22) Filed: Oct. 29, 2014

(51) Int. Cl. B63B 35/73; G06F 1/16

(52) U.S. Cl. CPC B63B 35/73; G06F 1/1656; G06F 1/1643

(57) ABSTRACT

A floatation accessory device is provided for an e-reading device.

### TECHNICAL FIELD

Examples described herein relate to a floatation accessory device for an e-reading device.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

Some electronic personal display devices are purpose built devices that are designed to perform especially well at displaying readable content. For example, a purpose built purpose build device may include a display that reduces glare, performs well in high lighting conditions, and/or mimics the look of text on actual paper. While such purpose built devices may excel at displaying content for a user to read, they may also perform other functions, such as displaying images, emitting audio, recording audio, and web surfing, among others.

There also exists numerous kinds of consumer devices that can receive services and resources from a network service. Such devices can operate applications or provide other functionality that links a device to a particular account of a specific service. For example, e-reader devices typically link to an online bookstore, and media playback devices often include applications which enable the user to access an online media library. In this context, the user accounts can enable the user to receive the full benefit and functionality of the device.

Certain computing devices, including electronic personal display devices, have been designed to be water proof, or at least water resistant, to prevent potential damage from water exposure. While such devices are water-proof or water resistant, the devices are generally known to submerge if inserted in water.

### BRIEF DESCRIPTION OF THE DRAWINGS

FIG. 1 illustrates a system for utilizing applications and providing e-book services on a computing device, according to an embodiment.

FIG. 2 illustrates an example of an e-reading device 200 or other electronic personal display device in coupled combination assembly with a floatation structure, according to an embodiment.

FIGS. 3A-3B illustrate an accessory device in which a floatation structure provides a cover for an e-reading device, according to one or more embodiments.

FIGS. 4A-D show an accessory device in which a floatation structure is provided as part of an enclosure for an e-reading device, according to another embodiment.

FIGS. 5A-C show another example of a floatation accessory device in which a floatation structure is provided as part of an enclosure for an e-reading device, according to a variation.

FIG. 6 shows an example a floatation accessory device combined with an e-reading device, according to another embodiment.

FIG. 7A and FIG. 7B show another example of a floatation accessory device in which a floatation structure is provided as part of an enclosure for an e-reading device, according to a variation.

### DETAILED DESCRIPTION

Examples described herein provide for a floatation accessory device for e-reading devices. In particular, a floatation accessory device is provided for e-reading devices which are water-resistant, so that such devices can be more readily enjoyed in pools, bathtubs and other water environments.

Examples described herein provide for a floatation accessory device for e-reading devices. In particular, a floatation accessory device is provided for e-reading devices which are water-resistant, so that such devices can be more readily enjoyed in pools, bathtubs and other water environments.

In one embodiment, an accessory device includes a floatation structure, and a coupling mechanism to couple the floatation structure to an e-reading device. The coupling mechanism can be structured to maintain the floatation structure coupled to the computing device in a partially or fully submerged environment, as well as in a non-submerged water environment. The floatation structure can be dimensioned to cover at least a portion of the computing device when coupled to the computing device in the non-submerged environment. Additionally, the floatation structure can include a volume and weight that is sufficient to render a combined buoyancy of the accessory device coupled to the computing device to be at least neutral in water.

According to some variations, a combined device assembly includes an e-reading device and a floatation accessory device. The e-reading device includes a touch-sensitive display screen, and the computing device may be structured to be water resistant.

In still another variation, an e-reading device is provided which includes a housing, a display screen and one or more internal components. The housing and display screen can be least water resistant to protect the one or more internal components from water. A floatation structure can be provided with the housing so that the computing device with the floatation structure being at least neutrally buoyant.

Still further, some embodiments provide for an additional feature of equipping a floatation accessory device with a water theme. For example, water-based functional features, such as water pockets or mirrors, can be integrated into any of the examples described herein. By way of another example, the accessory device can be provided with a skin or other content to carry a water theme, such as a literary water theme.

Among other benefits, examples described herein provide an accessory device or structure to attain buoyancy of an otherwise negatively buoyant (i.e. “non-buoyant”) computing device. In particular, an accessory device or structure can be combined with an e-reading device to make a floating e-reading device that is positively buoyant. More specifically, when positively buoyant, the combined accessory (or structure) and computing device can float from a submerged point to a waterline.

In a variation, an accessory device or structure can be combined with an e-reading device to make the e-reading device neutrally buoyant. When neutrally buoyant, the combined accessory (or structure) and computing device will not sink.

Examples described herein can operate in connection with an e-reading device that is water-proof or resistant. Among other benefits, examples such as described enable a water-proof or resistant e-reading device to be enjoyed in a water environment, such as in a pool or bathtub. Other benefits of examples described herein include for example, prevention of potential damage, and efficient recovery of the e-reading device if accidentally dropped in or water. Still further, examples described herein enable intended modes of interactive use of a floating e-reading device in a water environment.

In some variations, a positively buoyant, waterproof accessory enclosure may be provided that entirely encloses a computing device—and thereby provide both water proofing and buoyancy to the computing device. However, certain aspects of this disclosure recognize certain benefits that may be enjoyed by providing devices and related methods which add buoyancy to an otherwise non-buoyant computing device, but without completely enclosing the computing device.

Among other benefits, examples described herein enable a personal display device, such as an e-reading device, to float in water. Such device may also be configured to provide one or more additional benefits, such as to adjust one or more device settings upon detecting the presence of water and/or other extraneous objects on a display surface. The presence of water, dirt, debris, and/or other extraneous (e.g., undesired) objects on the surface of a display screen of an e-reading device may inhibit or otherwise impede one or more functions of the device. For example, the extraneous objects may be falsely interpreted as a user “touch” input by one or more touch sensors provided with the display. This may cause the computing device to malfunction (e.g., perform undesired actions) and/or prevent the device from responding to actual (e.g., desired) user inputs. Therefore, the e-reading device may adjust one or more device settings, in response to detecting the presence of one or more extraneous objects, in order to prevent the device from malfunctioning and/or to enable a user to continue operating the device in a safe and/or optimized manner.

“E-books” are a form of electronic publication that can be viewed on computing device with suitable functionality. An e-book can correspond to a literary work having a pagination format, such as provided by literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., e-reading apps) to view e-books. Still further, some devices (sometimes labeled as “e-readers”) can be centric towards content viewing, and e-book viewing in particular.

An “e-reading device” can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet device, an ultramobile computing device, or a wearable computing device with a form factor of a wearable accessory device (e.g., smart watch or bracelet, glasswear integrated with a computing device, etc.). As another example, an e-reading device can include an e-reading device, such as a purpose-built device that is optimized for an e-reading experience (e.g., with E-ink displays).

System Description

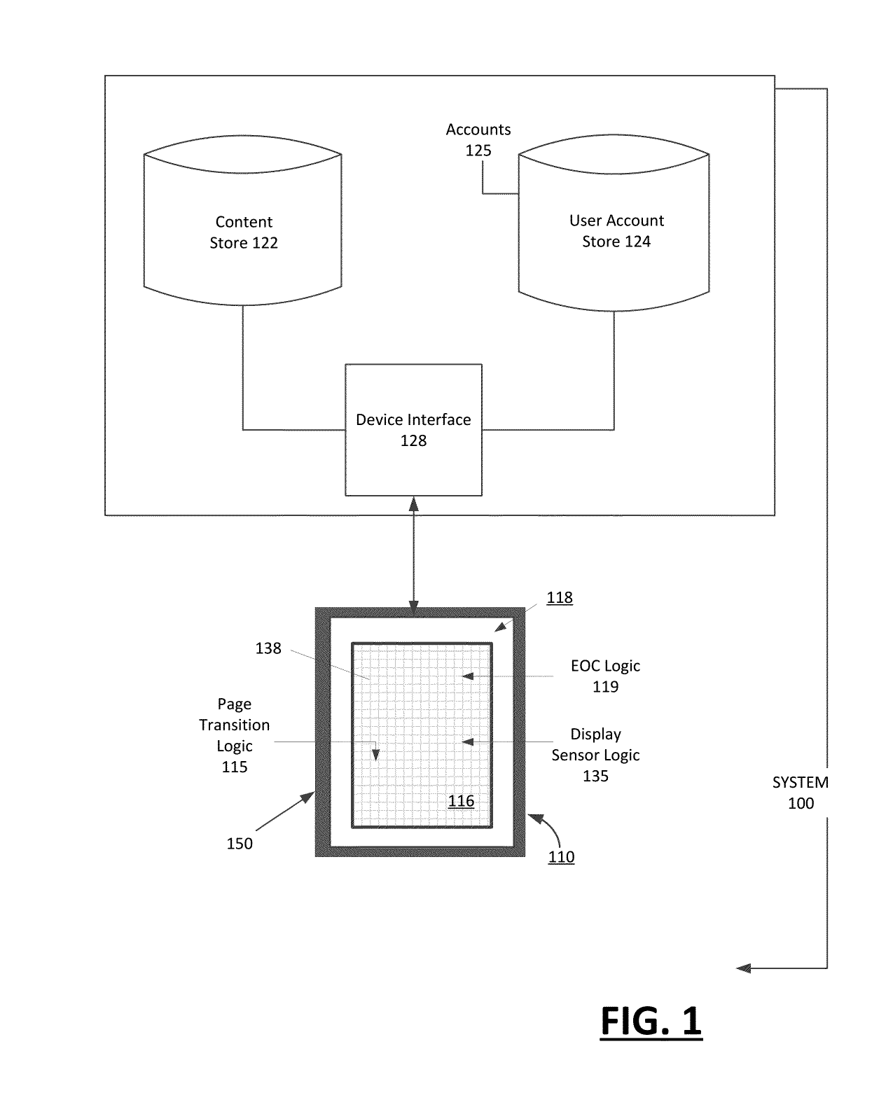

FIG. 1 illustrates a system 100 for utilizing applications and providing e-book services on a computing device that is capable of being used in a water environment, according to an embodiment. In an example of FIG. 1, system 100 includes an electronic display device, shown by way of example as an e-reading device 110, and a network service 120. In an example of FIG. 1, the e-reading device 110 is equipped with a floatation structure 150 (alternatively referred to as a “float structure” or “float”), for making the e-reading device 110 at least neutral in buoyancy. In some examples, the e-reading device 110 is not buoyant, but the addition of the floatation structure 150 as an accessory renders the combined device neutral or positive in buoyancy when the combined device is submerged in a water environment. In some variations, the e-reading device 110 is water-proof, or at least water resistant, and the floatation structure 150 provides an additional characteristic of buoyancy. While many examples as described below provide for the floatation structure 150 to be an accessory to the e-reading device 110, variations provide the floatation structure 150 to be an integrated or non-accessorized structure of a housing of the e-reading device 110.

In an example of FIG. 1, the e-reading device 110 is operable in either a dry or water environment in order to communicate with and receive resources from the network service 120. The network service 120 can include multiple servers and other computing resources that provide various services in connection with one or more applications that are installed on the e-reading device 110. By way of example, in one implementation, the network service 120 can provide e-book services which communicate with the e-reading device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, e-reading device 110 can run an e-reader application that links the device to the network service 120 and enables e-books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display. In an example of FIG. 1, the e-reading device 110 is water-proofed or water-resistant, with display features to promote e-reading in a we or dirty environment. Examples of e-reading devices with display features for promoting or enhancing e-reading activity in a we or dirty environment are described in U.S. patent application Ser. Nos. 14/498,661 and 14/498,722, both of which are hereby incorporated by reference in their respective entirety.

In additional detail, the network service 120 can include a device interface 128, a resource store 122 and a user account store 124. The user account store 124 can associate the e-reading device 110 with a user and with an account 125. The account 125 can also be associated with one or more application resources (e.g., e-books), which can be stored in the resource store 122. The device interface 128 can handle requests from the e-reading device 110, and further interface the requests of the device with services and functionality of the network service 120. The device interface 128 can utilize information provided with a user account 125 in order to enable services, such as purchasing downloads or determining what e-books and content items are associated with the user device. Additionally, the device interface 128 can provide the e-reading device 110 with access to the content store 122, which can include, for example, an online store. The device interface 128 can handle input to identify content items (e.g., e-books), and further to link content items to the account 125 of the user.

As described further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

With reference to an example of FIG. 1, e-reading device 110 can include a display screen 116 and a housing 118. In an embodiment, the display screen 116 is touch-sensitive, to process touch inputs including gestures (e.g., swipes). For example, the display screen 116 may be integrated with one or more touch sensors 138 to provide a touch sensing region on a surface of the display screen 116. For some embodiments, the one or more touch sensors 138 may include capacitive sensors that can sense or detect a human body's capacitance as input. In the example of FIG. 1, the touch sensing region coincides with a substantial surface area, if not all, of the display screen 116. Additionally, the housing 118 can also be integrated with touch sensors to provide one or more touch sensing regions, for example, on the bezel and/or back surface of the housing 118.

In some variations, the combination of the housing 118 and display screen 116 are water-proof or water-resistance. The floatation structure 150 can be provided as an accessory, such as a cover or enclosure which when submerged in water results in the device 110 being buoyant. In such an example, the floatation structure 150 can permit ingress of water when the device is submerged in a water environment, such that water makes contact or envelopes the housing 118. In an example of FIG. 1, the water-proofing or resistance is provided by the housing 118 and display screen 116, rather than the floatation structure 150 which can be an accessory.

According to some embodiments, the e-reading device 110 includes specialized features to enhance reading or use activities in we environments. In one implementation, the e-reading device 110 includes display sensor logic 135 to detect and interpret user input made through interaction with the touch sensors 138. By way of example, the display sensor logic 135 can detect a user making contact with the touch sensing region of the display screen 116. More specifically, the display sensor logic 135 can detect taps, multiple taps, and/or gestures made through user interaction with the touch sensing region of the display screen 116. Furthermore, the display sensor logic 135 can interpret such interactions in a variety of ways. For example, each interaction may be interpreted as a particular type of user input corresponding with a change in state of the display 116.

For some embodiments, the display sensor logic 135 may further detect the presence of water, dirt, debris, and/or other extraneous objects on the surface of the display 116. For example, the display sensor logic 135 may be integrated with a water-sensitive switch (e.g., such as an optical rain sensor) to detect an accumulation of water on the surface of the display 116. In a particular embodiment, the display sensor logic 135 may interpret simultaneous contact with multiple touch sensors 138 as a type of non-user input. For example, the multi-sensor contact may be provided, in part, by water and/or other unwanted or extraneous objects (e.g., dirt, debris, etc.) interacting with the touch sensors 138. Specifically, the e-reading device 110 may then determine, based on the multi-sensor contact, that at least a portion of the multi-sensor contact is attributable to water and/or other extraneous objects.

For some embodiments, the e-reading device 110 further includes other features that are specialized to enhance e-reading activity and other uses in we environments. In an example of FIG. 1, the e-reading device 110 includes an extraneous object configuration (EOC) logic 119 to adjust one or more settings of the e-reading device 110 to account for the presence of water and/or other extraneous objects being in contact with the display screen 116. For example, upon detecting the presence of water and/or other extraneous objects on the surface of the display screen 116, the EOC logic 119 may power off the e-reading device 110 to prevent malfunctioning and/or damage to the device 110. For some embodiments, the EOC logic 119 may reconfigure the e-reading device 110 to respond, and/or not respond, to particular types of user interactions (e.g., gestures) that are subsequently detected via the touch sensors 138. This enables a user to continue operating the e-reading device 110 even with the water and/or other extraneous objects present on the surface of the display screen 116.

In some embodiments, the e-reading device 110 includes features for providing functionality related to displaying paginated content. The e-reading device 110 can include page transitioning logic 115, which enables the user to transition through paginated content. The e-reading device 110 can display pages from e-books, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch sensing region of the display screen 116. For example, the user may swipe the surface of the display screen 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state. For example, a user can touch and hold the surface of the display screen 116 in order to cause a cluster or chapter page state transition, while a tap in the same region can effect a single page state transition (e.g., from one page to the next in sequence). In another example, a user can specify page turns of different kinds or magnitudes through single taps, sequenced taps or patterned taps on the touch sensing region of the display screen 116.

As described with some examples, the housing 118 of the e-reading device 110 can include structural features and characteristics for making the e-reading device 110 water-proof or resistance. The floatation structure 150 can couple or otherwise combine with the housing 118 to enable the combined device to have at least a neutral buoyancy. At a neutral buoyancy, the combined device will remain substantially at a constant level when a submersion event occurs (e.g., combined device dropped in pool or bathtub). In variations, the combined device will have a positive buoyancy, meaning the device will float up to a surface when submerged. The buoyancy of the combined device can be determined in part by the positive buoyancy of the floatation structure 150, which includes a characteristic volume and density (or weight) from which its characteristic buoyancy is determined. In one implementation, the floatation structure 150 is dimensioned and configured structurally by volume and weight to target the combined device into having neutral buoyancy, rather than positive buoyancy. By dimensioning and structurally configuring the floatation structure 150 to have only sufficient buoyancy to result in a neutral buoyant combined device, examples recognize that the volume and weight of the floatation structure can be lessened. As an accessory device, the floatation structure 150 can be made less bulky, for example, by targeting the buoyancy of the floatation structure 150 to yield substantially neutral (but not positive) buoyancy for the combined device.

Hardware Description

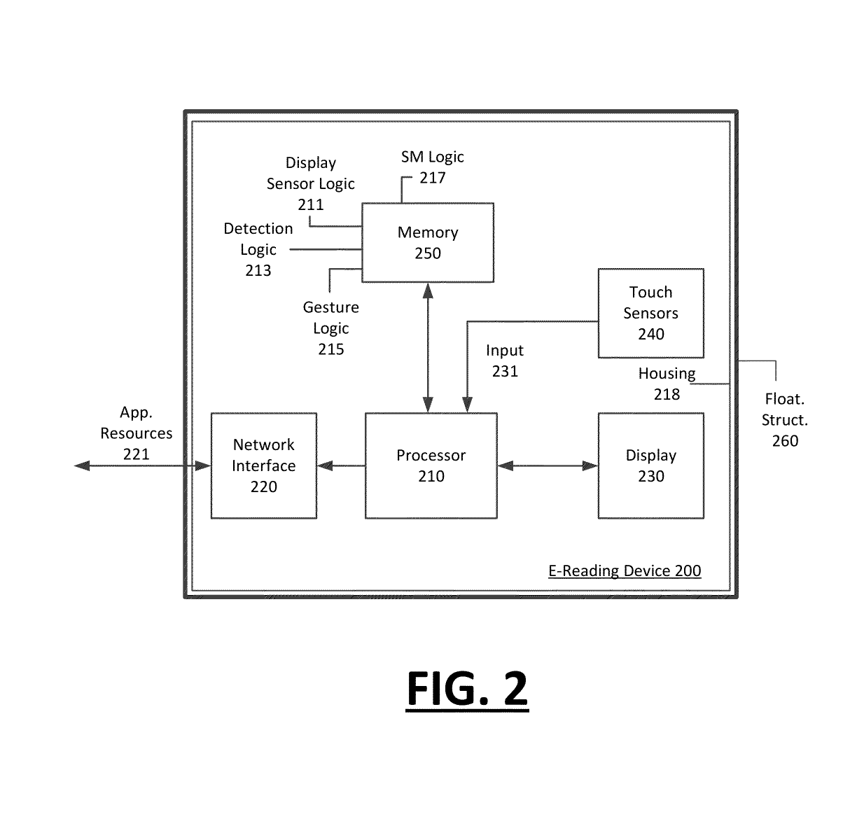

FIG. 2 illustrates an example of an e-reading device 200 or other electronic personal display device in coupled combination assembly with a floatation structure, according to an embodiment. In an example of FIG. 2, an e-reading device 200 can correspond to, for example, the device 110 as described above with respect to FIG. 1. With reference to FIG. 2, e-reading device 200 includes a processor 210, a network interface 220, a display 230, one or more touch sensor components 240, and a memory 250. In an example of FIG. 2, the e-reading device is optimized and accessorized for a we environment. A housing 218 of the e-reading device 200 can be equipped with water-proofing or resistant features. In a variation, the display 230 can also include structural aspects to enhance water resistance or proofing. Still further, in an example of FIG. 2, the e-reading device 200 includes a floatation structure 260 to further enhance use of the device in a we environment (e.g., poolside use, shower or bath use, on boat, etc.).

The processor 210 can implement functionality using instructions stored in the memory 250. Additionally, in some implementations, the processor 210 utilizes the network interface 220 to communicate with the network service 120 (see FIG. 1). More specifically, the e-reading device 200 can access the network service 120 to receive various kinds of resources (e.g., digital content items such as e-books, configuration files, account information), as well as to provide information (e.g., user account information, service requests etc.). For example, e-reading device 200 can receive application resources 221, such as e-books or media files, that the user elects to purchase or otherwise download from the network service 120. The application resources 221 that are downloaded onto the e-reading device 200 can be stored in the memory 250.

In some implementations, the display 230 can correspond to, for example, a liquid crystal display (LCD) or light emitting diode (LED) display that illuminates in order to provide content generated from processor 210. In some implementations, the display 230 can be touch-sensitive. For example, in some embodiments, one or more of the touch sensor components 240 may be integrated with the display 230. In other embodiments, the touch sensor components 240 may be provided (e.g., as a layer) above or below the display 230 such that individual touch sensor components 240 track different regions of the display 230. Further, in some variations, the display 230 can correspond to an electronic paper type display, which mimics conventional paper in the manner in which content is displayed. Examples of such display technologies include electrophoretic displays, electrowetting displays, and electrofluidic displays.

The processor 210 can receive input from various sources, including the touch sensor components 240, the display 230, and/or other input mechanisms (e.g., buttons, keyboard, mouse, microphone, etc.). With reference to examples described herein, the processor 210 can respond to input 231 from the touch sensor components 240. In some embodiments, the processor 210 responds to inputs 231 from the touch sensor components 240 in order to facilitate or enhance e-book activities such as generating e-book content on the display 230, performing page transitions of the e-book content, powering off the device 200 and/or display 230, activating a screen saver, launching or closing an application, and/or otherwise altering a state of the display 230.

In some embodiments, the memory 250 may store display sensor logic 211 that monitors for user interactions detected through the touch sensor components 240, and further processes the user interactions as a particular input or type of input. In an alternative embodiment, the display sensor logic 211 may be integrated with the touch sensor components 240. For example, the touch sensor components 240 can be provided as a modular component that includes integrated circuits or other hardware logic, and such resources can provide some or all of the display sensor logic 211 (see also display sensor logic 135 of FIG. 1). For example, integrated circuits of the touch sensor components 240 can monitor for touch input and/or process the touch input as being of a particular kind. In variations, some or all of the display sensor logic 211 may be implemented with the processor 210 (which utilizes instructions stored in the memory 250), or with an alternative processing resource.

For some embodiments, the display sensor logic 211 may detect the presence of water and/or other extraneous objects on the surface of the display 230. For example, the display sensor logic 211 may determine that extraneous objects are present on the surface of the display 230 based on a number of touch-based interactions detected via the touch sensors 240 and/or a contact duration (e.g., a length of time for which contact is maintained with a corresponding touch sensor 240) associated with each interaction. More specifically, the display sensor logic 211 may detect the presence of water and/or other extraneous objects if a detected interaction falls outside a set of known gestures (e.g., gestures that are recognized by the e-reading device 200). Such embodiments are discussed in greater detail, for example, in co-pending U.S. patent application Ser. Nos. 14/498,661 and 14/498,722, both of which are hereby incorporated by reference in their respective entirety.

In one implementation, the display sensor logic 211 includes detection logic 213 and gesture logic 215. The detection logic 213 implements operations to monitor for the user contacting a surface of the display 230 coinciding with a placement of one or more touch sensor components 240. The gesture logic 215 detects and correlates a particular gesture (e.g., pinching, swiping, tapping, etc.) as a particular type of input or user action. The gesture logic 215 may also detect directionality so as to distinguish between, for example, leftward or rightward swipes.

For some embodiments, the display sensor logic 211 further includes splash mode (SM) logic 217 for adjusting one or more settings of the e-reading device 200 in response to detecting the presence of water and/or other extraneous objects on the surface of the display 230. For example, the splash mode logic 217 may configure the e-reading device 200 to operate in a “splash mode” when water and/or other extraneous objects are present (e.g., “splashed”) on the surface of the display 230. While operating in splash mode, one or more device configurations may be altered or reconfigured to enable the e-reading device 200 to be continuously operable even while water and/or other extraneous objects are present on the surface of the display 230. More specifically, the splash mode logic 217 may perform one or more operations to mitigate or overcome the presence of extraneous objects (e.g., such as water) on the surface of the display 230. Accordingly, the splash mode logic 217 may be activated by the display sensor logic 211 upon detecting the presence of extraneous objects on the surface of the display 230.

For some embodiments, the splash mode logic 217 may reconfigure one or more actions (e.g., input responses) that are to be performed by the e-reading device 200 in response to user inputs. For example, the splash mode logic 217 may disable certain actions (e.g., such as performing multi-page and/or chapter transitions) that are triggered by multi-contact user interactions (e.g., requiring concurrent contact at multiple distinct locations on the display 230) and/or persistent user interactions (e.g., requiring continuous contact with the touch sensors 240 over a given duration) because such interactions could be misinterpreted by the gesture logic 215 given the presence of extraneous objects on the surface of the display 230. More specifically, while operating in splash mode, the e-reading device 200 may be able to perform only a limited subset of actions that the device 200 would otherwise be able to perform (e.g., when operating in a “normal mode”). In a particular implementation, the functionality of the e-reading device 200 may be limited to performing page-turning actions (e.g., regardless of the received user input). For example, multi-page and/or chapter transition inputs may all be interpreted by the splash mode logic 217 as single page-turn inputs.

Additionally, and/or alternatively, the splash mode logic 217 may enable a new set of actions to be performed by the e-reading device 200. For example, the splash mode logic 217 may remap one or more user inputs (and/or gestures) to the new set of actions. The new set of actions may include actions to be performed by the e-reading device 200 only when water and/or other extraneous objects are present on the surface of the display 230 (e.g., such as notifying the user to clean or wipe off the display 230). More specifically, the new set of actions may enable the e-reading device 200 to operate in an optimized manner while the water and/or other extraneous objects are present.

Further, for some embodiments, the splash mode logic 217 may reconfigure the set of inputs that can be processed by the e-reading device 200. For example, the splash mode logic 217 may disable certain user inputs (e.g., multi-page and/or chapter transition inputs) that correspond with multi-contact and/or persistent user interactions and could therefore be misinterpreted by the gesture logic 215 given the presence of extraneous objects on the surface of the display 230. More specifically, while operating in splash mode, the e-reading device 200 may respond to only a subset of inputs that the device 200 would otherwise be responsive to (e.g., when operating in the normal mode). In a particular implementation, the splash mode logic 217 may respond only to page-turn inputs. For example, inputs corresponding to multi-page and/or chapter transitions may elicit no response from the e-reading device 200 when operating in splash mode.

Still further, for some embodiments, the splash mode logic 217 may reconfigure a set of gestures that are recognizable by the e-reading device 200. For example, the splash mode logic 217 may disable certain gestures (e.g., gestures involving multi-contact and/or persistent user interactions) that could be misinterpreted by the gesture logic 215 given the presence of extraneous objects on the surface of the display 230. More specifically, while operating in splash mode, the e-reading device 200 may recognize only a subset of gestures that the device 200 would otherwise be able to recognize (e.g., when operating in the normal mode). In a particular implementation, the splash mode logic 217 may only recognize gestures corresponding with a single tap. For example, tap-and-hold gestures and/or swiping gestures may elicit no response from the e-reading device 200 when operating in splash mode. More specifically, the splash mode logic 217 may recognize a tapping gesture only upon detecting a contact release or finger liftoff (e.g., as opposed to detecting the initial contact). This may help ensure that the contact or interaction being detected is in fact a tapping gesture and not another extraneous object coming into contact with the surface of the display 230.

For other embodiments, the splash mode logic 217 may process a user input only if a contact pressure associated with the corresponding user interaction (e.g., gesture) exceeds a pressure threshold. For example, the touch sensors 240 may be pressure-sensitive, and may thus detect the amount of force applied by an object while in contact with the surface of the display 230. The magnitude of that force (e.g., the contact pressure) may be associated with each input 231 sent to the processor 210. Accordingly, the processor 210, in executing the splash mode logic 217, may selectively process the inputs 231 based on the contact pressure associated with each input 231. For example, the contact pressure associated with water, dirt, debris, and/or other extraneous objects may be substantially smaller than the contact pressure that can be applied through human interaction. Thus, in order to distinguish intentional user interactions from contact by extraneous objects, the splash mode logic 217 may process a particular input 231 only if the contact pressure associated with that input exceeds a particular pressure threshold.

As described in various embodiments, the housing 218 of the e-reading device 200 can include structural features and characteristics for making the e-reading device 200 water-proof or resistance. The floatation structure 260 can couple or otherwise combine with the housing 218 to enable the combined device to have at least a neutral buoyancy.

Floatation Structure for Accessory Device

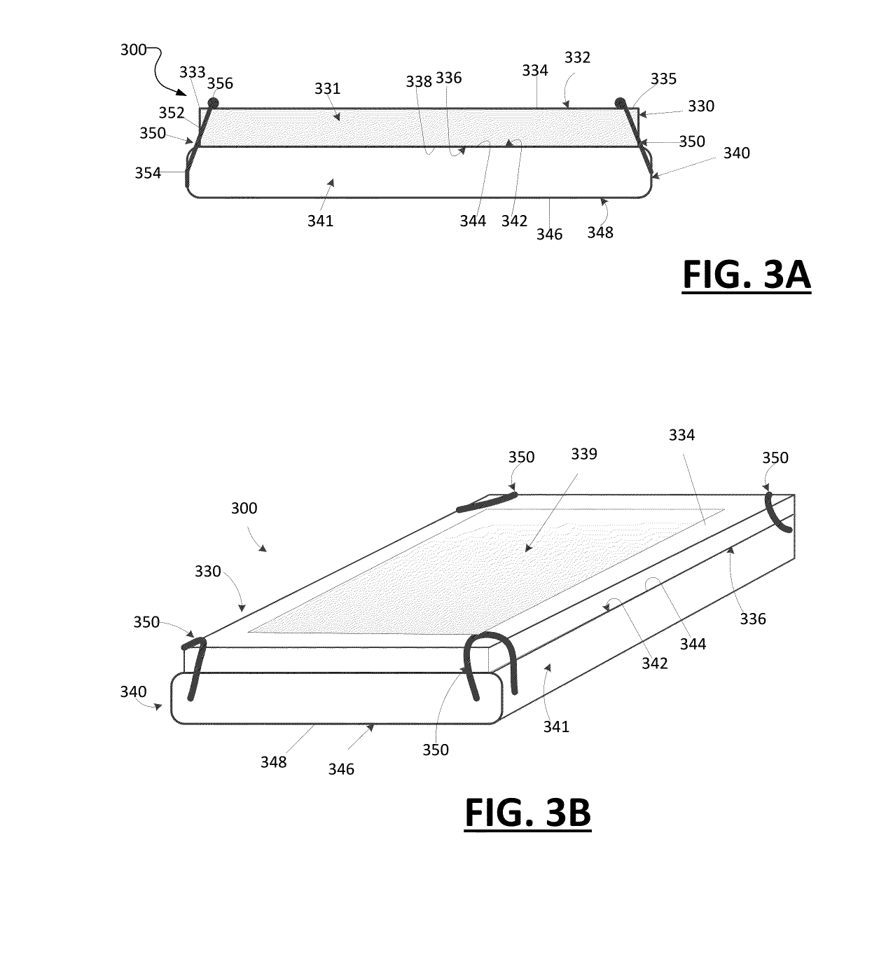

FIGS. 3A-3B illustrate an accessory device in which a floatation structure provides a cover for an e-reading device, according to one or more embodiments. In more detail, a device assembly 300 represents a combined device comprising an e-reading device 330 coupled to an accessory device that corresponds to a floatation structure 340. In the example shown, the e-reading device 330 includes a body 331 with a front side 332 that includes a front face 334, and a back side 336 with a back face 338. Floatation structure 340 includes a body 341 with a front side 342 that includes a front face 344, and a back side 346 that includes a back face 348.

In an example such as shown with FIG. 3A and FIG. 3B, the floatation structure 340 is coupled to the e-reading device 330 to provide utility when the device is in both a submerged water environment and in a non-submerged environment. In the non-submerged environment (e.g., device used in any dry environment, such as in bed or at a desk), the floatation structure 340 serves as a protective cover that protects at least one of the front face 334 or back face 338 of the e-reading device 330. In an example of FIG. 3A, the floatation structure 340 is positioned behind the back side 336, so that it underlies the e-reading device 330 at the backside. In this configuration, the front face 344 of the floatation structure 340 is abutted against the back face 338 of the e-reading device 330.

Furthermore, while an example of FIGS. 3A-B illustrate the floatation structure 340 providing a cover for the back face 338 of the e-reading device 330, variations to structure or use of the floatation structure 340 can provide for its use as a front cover, so that it overlays the front face 334 and the display surface 339. Still further, in variations, the floatation structure 340 can be structured such that it can be pivoted from overlaying the front face 334 of the e-reading device 330 to underlying the back face 338. The pivot can, for example, situate the floatation structure 340 as a protective cover for the display screen 339 when the use of the combined device is in a dry environment, and further as a float when the combined device is in a submerged environment.

One or more coupling mechanisms 350 couple the e-reading device 330 to the floatation structure 340. The coupling mechanisms 350, according to an example of FIGS. 3A-B, are provided as straps 352 that extend between the floatation structure 340 and the e-reading device 330. In one implementation, the straps 352 are attached at both ends at attachment points 354 to floatation structure 340, and form coupling loops 356 which serve to structurally capture and secure the e-reading device 330. In one implementation, coupling loops 356 are provided at each of four corners of the float 340 in a configuration such that they loop over and around the four corresponding corners of e-reading device 330. According to this configuration, coupling loops 356 couple the e-reading device 330 to the float 340 in relatively secured engagement.

In an implementation of FIGS. 3A-B, coupling loops 356 are adjustable such that the coupling of the e-reading device 330 and floatation structure 340 is adjustable between the coupled configuration as shown, and an uncoupled configuration (not shown) in which the e-e-reading device 330 and floatation structure 340 are separated from one another. Such may be achieved, for example, by providing the coupling mechanism 350 with sufficient elasticity to enable such adjustability—and which may also provide the additional benefit of holding the e-reading device 330 against the floatation structure 340 with sufficient force so that the two devices do not separate when dropped from a given height into a depth of water. In a variation, the straps of coupling mechanism 350 can also simply be sufficiently flexible to enable the loops to be adjusted on or off of the computing device corners.

The floatation structure 340 can be constructed with appropriately buoyant material and dimension, relative to the computing device intended for this coupled assembly, to provide sufficient buoyancy such that the combined float-computing device assembly has positive buoyancy. For example, e-reading device 330 can have a characteristic volume and density that is negatively buoyant. The floatation structure 340 can be dimensioned and configured such that the combined buoyance of the floatation structure 340 and e-reading device 330 is at least neutral.

In an example of FIG. 3B, the floatation structure 340 does not enclose e-reading device 330. Rather, in an example of FIGS. 3A-B, the coupled configuration of floatation structure 340 with e-reading device 330 leaves a display screen 339 on front face 334 of e-reading device 330 uncovered. This allows unobstructed modes of use for display screen 339, to enable unobstructed viewing and interaction (e.g., via touch inputs) with the display screen that would otherwise not be provided by a complete enclosure.

According to one further embodiment, the e-reading device 330, including display surface 339, is itself already water proof (or in other embodiments may be at least water resistant). Thus, floatation structure 340 is configured to address a need for buoyancy, independent of water proofing or resistance. Accordingly, an assembly 300 of the combined device is both buoyant, by way of the floatation structure 340, and water proof (or resistant), by way of the e-reading device's own characteristics—thus enhancing the overall protection against potential damage, and/or usability, of the computing device while floating. Despite this highly beneficial example depicted, variations to examples described provide for the floatation structure 340 to be used with computing devices that are not water proof or resistant, and with benefits of buoyancy still enjoyed—despite a possible absence of water proofing or resistance (or that such additional characteristics may be provided otherwise by other approaches).

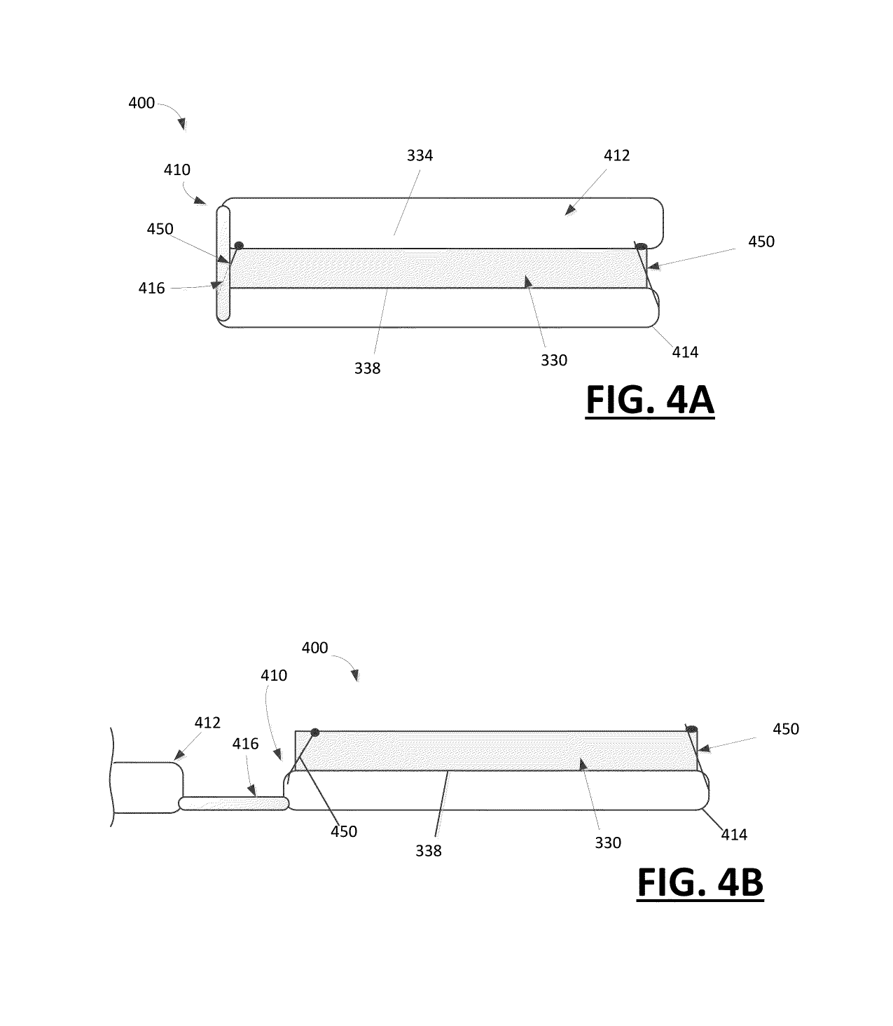

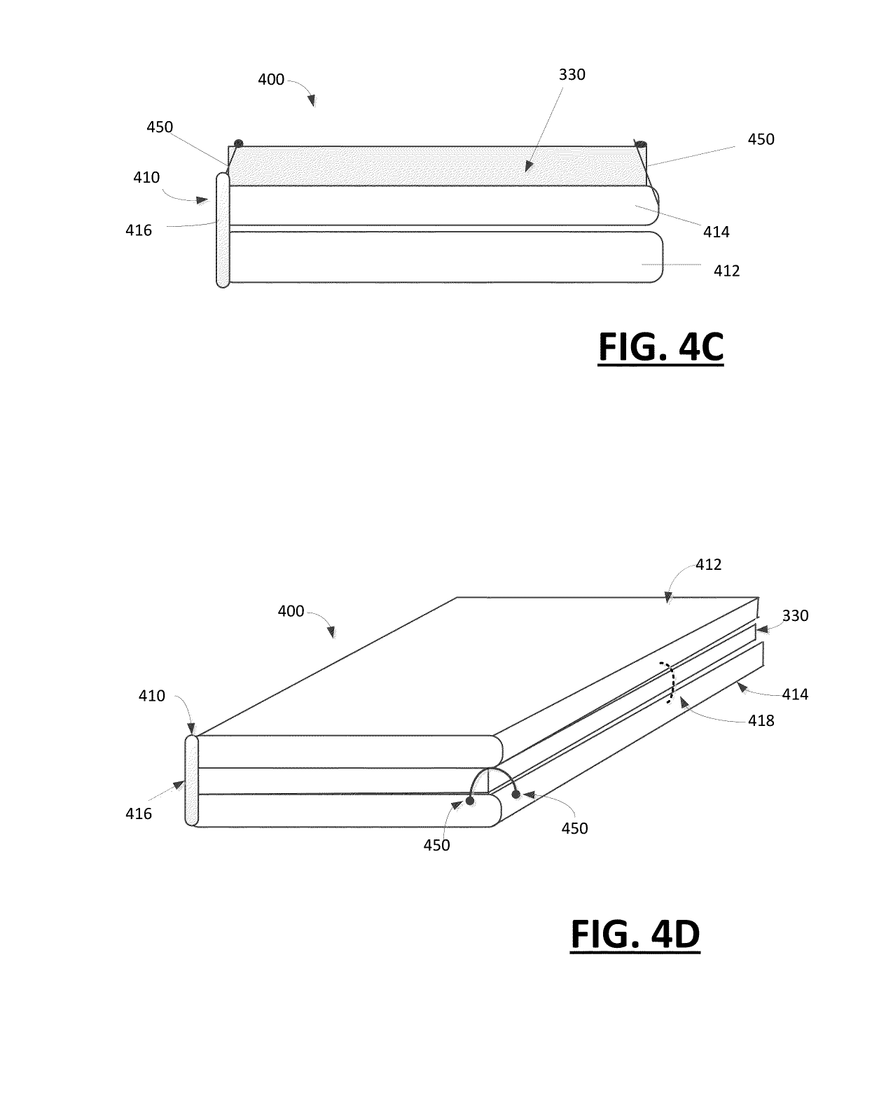

FIGS. 4A-D show an accessory device in which a floatation structure is provided as part of an enclosure for an e-reading device, according to another embodiment. In more detail, a device assembly 400 represents a combination of e-reading device 330 and enclosure 410. According to an example of FIGS. 4A-D, the enclosure 410 includes a “book”-like configuration, comprising a front cover 412 and a back cover 414 that are coupled together by an interconnecting structure, shown as spine 416 (e.g. flap or hinge). In example of FIGS. 4A-D, the enclosure 410 is coupled to e-reading device 330 by strap couplers 450 coupling e-reading device 330 to back cover 414 of the enclosure. The use of strap couplers 450 to couple back cover 414 to the e-reading device 330 can be similar to that shown and described by an example of FIGS. 3A-B (e.g., see coupling mechanism 350). In such a configuration, the spine 416 and front cover 412 can form a book-like partial enclosure over front side 332 and face 334 of e-reading device 330.

The front cover 412 can extend from the spine 416 to enable the front cover to pivot and adjust between a closed position, extended position, and fully open or wrapped position. With reference to FIG. 4A, in the closed position, front cover 412 abuts and overlays front face 334 of e-reading device 330, and the back cover 414 underlies the back face 338 of the e-reading device 330. In one implementation, the coupling mechanism 450 secures the e-reading device 330 to the back cover 414 using straps or coupling loops, as described with, for example, FIGS. 3A-B.

With reference to FIG. 4B, in the extended position, the front cover 412 is extended outward in an approximate 180 degree orientation relative to the closed orientation. The front cover 412 can be pivoted about the spine 416 up and off of front face 334 of e-reading device 330, so as to extend sideways from the e-reading device 330. The open orientation can simulate an orientation in which a user “opens” the enclosure 410 to expose the display surface in a manner that resembles a book cover.

With reference to FIG. 4C, in a fully open or wrapped position, the front cover 412 may be rotated further around the spine 416 until it is inverted around and back behind back cover 414. The front cover 412 can have a stacked configuration with the front cover 412 below the back cover 414, which is below the e-reading device 330.

According to one particular further embodiment, front cover 412 is constructed with a positive first buoyancy that is greater than a second buoyancy of the back cover 414, and is sufficient to provide at least the primary buoyancy contribution in the overall assembly of float 410 with e-reading device 330. In such an arrangement, the closed configuration for assembly 400 may bias its orientation in water to float with the front cover 412 at the top of the assembly 400 at the water surface, and the back cover 414 below (with the e-reading device 330 in between). The buoyancy of front cover 412, and or the overall resulting assembly 400, may be such that front cover 412 is partially submerged in the floating configuration.

Despite certain benefits provided by this particular orientation-biased floating arrangement noted above, other detailed embodiments are also contemplated. For example, the back cover 414 may also be positively buoyant—either equal to that of the front cover, or less than the front cover (in which case the biased orientation of front cover 412 above back cover 414 may still be achieved during floating). Moreover, the back cover 414 can be the more buoyant versus front cover 412, resulting in an opposite floating bias toward the back cover 414 rising above the front cover 412 when floating. Moreover, the e-reading device 330 may be coupled to the enclosure 410 in a reversed upside-down configuration versus that shown in an example of FIG. 4A-D. For example, in the upside-down configuration, the front side 332 and back side 336 of the e-reading device 330 are reversed relative to the front cover 412 and back cover 414 of the float 410. Such an arrangement can enable sufficient buoyancy to provide floatation to the e-reading device 330, albeit the front face 334 of the e-reading device would be directed downward.

FIG. 4D is an isometric view of the enclosure 410 in the closed positon. In the closed position, the combined device 400 can be modeled as a book cover or jacket, with the front cover 412 overlaying the front face 334 of the e-reading device 330, and the back cover 414 underlying the back face 338. The spine 416 can enable the front cover 412 to pivot between the closed, extended and fully opened or wrapped position. In some variations, a securement 418 can further fasten the front and/or back cover 414, 418 to each other, thereby increasing the securement of the e-reading device and enclosure 410.

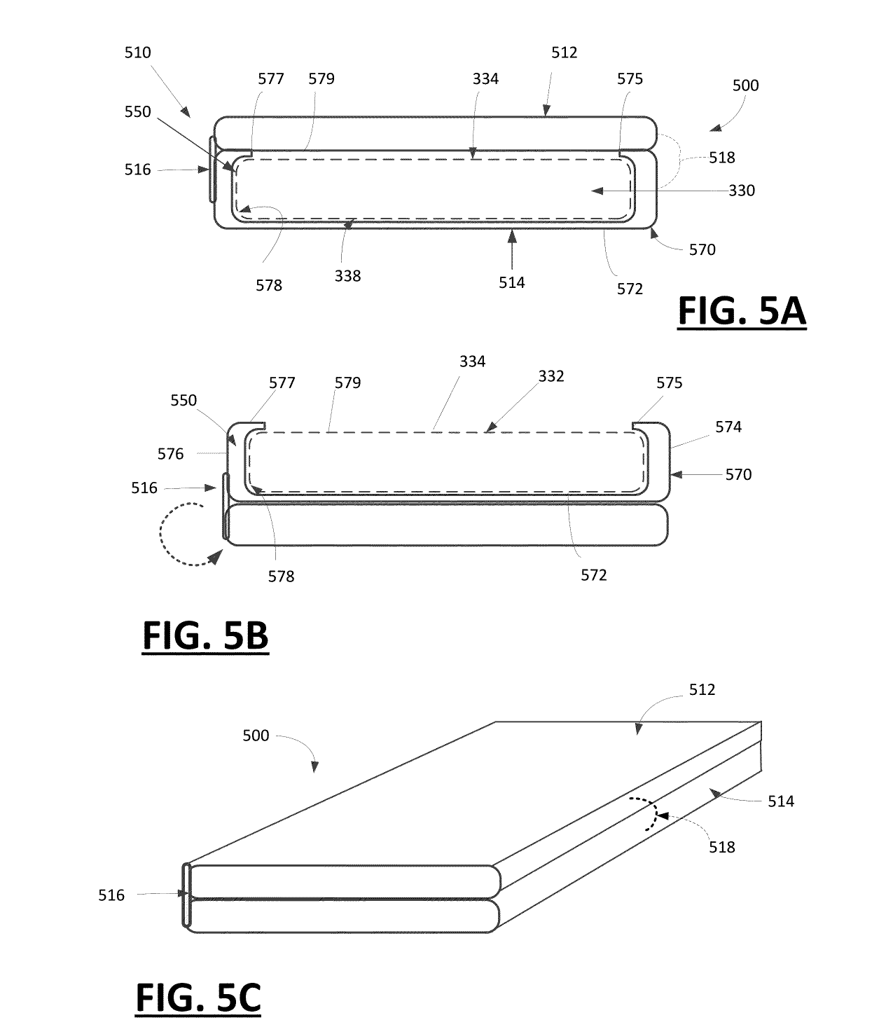

FIGS. 5A-C show another example of a floatation accessory device in which a floatation structure is provided as part of an enclosure for an e-reading device, according to a variation. In more detail, a device assembly 500 represents a combination of e-reading device 330 and enclosure 510. More specifically, FIGS. 5A-C show a variation of an enclosure 510 which includes or is comprised of a floatation structure, using an alternative coupling mechanism to couple the enclosure and e-reading device.

The enclosure 510 includes a front cover 512, back cover 514, spine 516 and housing 570 with an interior coupling structure 550. In contrast to, for example, an embodiment of FIGS. 4A-D, enclosure 510 includes the coupling structure 550 which receives and retains the e-reading device 330. In one implementation, the coupling structure 550 can be C-shaped molded or shaped structures within housing 570, the structures being dimensioned to receive a thickness of the e-reading device 330.

In one implementation, the housing 570 includes a back wall 572 that extends between relative bottom ends of side walls 574 and 576. Side walls 574, 576 extend upwardly from back wall 572 and terminate at inwardly oriented, relative opposite facing ribs or flanges 575, 577, respectively—thus leaving open a space or window 579. This configuration thus provides a partially enclosed chamber 578 which is sized with appropriate geometry and dimensions to receive and house e-reading device 330. According to one feature of an embodiment shown, the separation between flanges 575, 577 is dimensioned to be suitably smaller than the cross-sectional dimension of the e-reading device 330 along that similar axis, and in order to thus provide a fit to receive and retain the e-reading device 330. E-reading device 330 may be positioned into this chamber 578, for example, by providing the side walls 574, 576, or their respective inward flanges 575, 577, or both, sufficient flexible to allow the e-reading device to be pushed downwardly through the flanges 575, 577 with sufficient force to distend them down or apart (and/or the sidewalls themselves) to allow entry of the e-reading device 330 to the chamber 578. In another embodiment, an opening or slot (not shown) may be provided at one or both ends of housing 570 to allow sliding insertion of e-reading device 330 into the chamber 578.

In one implementation, front cover 512 is adjustable between (i) a closed configuration (as shown in FIG. 5A), in which the front cover 512 overlays the front face 332 of the e-reading device 330, (ii) an extended position in which the front cover 512 extends substantially horizontally (or at 180 degrees), and (iii) an open or wrapped configuration, in which the front cover 512 is wrapped around the back cover 514 (shown in FIG. 5B) (or between 270 and 360 degrees), so that the front cover 512 underlies the back of the e-reading device 330. One or more additional coupling mechanisms 518 can be employed to hold front cover 512 securely in the closed configuration with the back cover 514. However, instead of such adjustments being made between these respective configurations relative to a back cover (as provided in the prior embodiment), in the embodiment of FIGS. 5A-C the front cover 512 is adjustable relative to the housing 570 (and also thus the e-reading device 330 contained therein).

FIG. 5C is an isometric view of the enclosure 510 in the closed positon. In the closed position, the combined device 500 can be modeled as a book cover or jacket, with the front cover 512 overlaying the front face 334 of the e-reading device 330, and the back cover 514 underlying the back face 338.

The spine 516 can enable the front cover 512 to pivot between the closed, extended and fully opened or wrapped position. In an example such as shown by FIG. 5A through FIG. 5C, the spine 516 is a structure that slides downward to enable more freedom from the front cover 512 to pivot and wrap to the underside of the combined device 500.

In one implementation of FIG. 5A through FIG. 5C, the front cover 512 provides the primary buoyancy of the accessory device 510. When the front segment 512 is positioned at the underside of the e-reading device, the front segment 512 can be partially or fully submerged to provide buoyancy and maintain a remainder of the combined device out of the water.

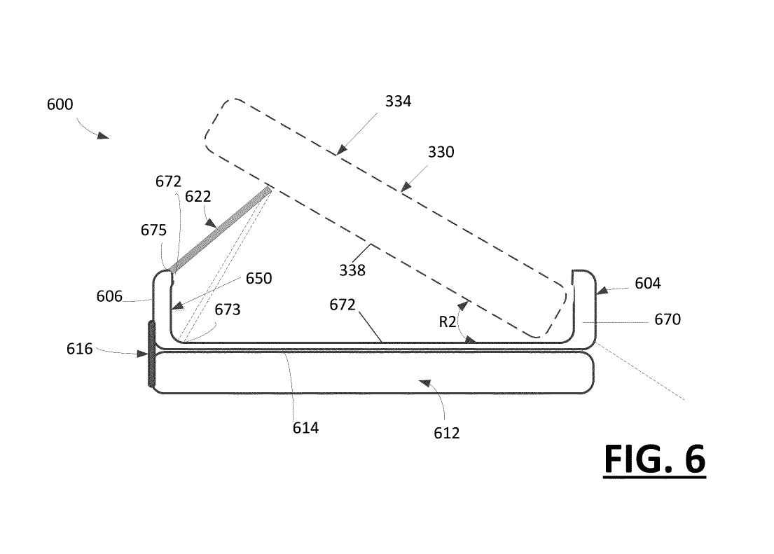

FIG. 6 shows an example a floatation accessory device combined with an e-reading device, according to another embodiment. A combined assembly 600 includes e-reading device 330 and a floatation accessory device 610 having an adjustable support structure 622 to lift the e-reading device into a viewable position. The floatation accessory device 610 includes housing 670, with coupling structure 650 to receive the e-reading device 330. In a variation of FIG. 6, the coupling structure 650 receives the e-reading device 330 in a lengthwise orientation, so that a bottom face 338 of the e-reading device 330 is positioned against an interior surface 672 of the housing 670. The coupling structure 650 includes retention walls 604, 606 which are dimensioned for the thickness of the e-reading device 330.

In an example of FIG. 6, the e-reading device 330 can be adjusted from a full contained position to a partially contained position. In the fully contained position, the floatation accessory device 610 can operate similar to an example of FIG. 5A through FIG. 5C. In particular, a front cover 612 can pivot from between a closed position, extended position, and fully open or wrapped position (as shown in FIG. 6). In the fully open or wrapped position, the front cover 612 is positioned against a bottom face 614 of the accessory device 610. The hinged coupling structure 616 can translate and/or pivot to enable the degree of movement from the front cover 612.

In one implementation, the front cover 612 provides the buoyancy of the accessory device 610 as a whole. For example, the front cover 612 can be positively buoyant, while the housing 670 is not, and the combined front cover 612 and housing 670 can provide a neutral or slightly positive buoyancy. In such a configuration, the front cover 612 needs to be partially submerged in order for the combined assembly 600 to float. Thus, for example, a user can manipulate the front cover 612 from the closed position to the fully open position (shown in FIG. 6A) before resting the combined assembly in a water environment (e.g., pool or hot tube). If the front cover 612 is not moved to the fully open or wrapped position, the device itself may not float until the front cover 612 is partially submerged, meaning the e-reading device 330 may become fully submerged before the combined assembly 600 can float. The e-reading device 330 may be water-proof in order to protect against submersion when the assembly 600 is in, for example, the closed position, as the e-reading device 330 could be substantially submerged under the front cover 612.

With an example of FIG. 6, when the combined assembly 600 is in the fully open position, the adjustable support structure can slide from a flat orientation with respect to the interior surface 672 of the housing to an angled orientation in which the e-reading device is held upright for viewing. In moving into the angled position, a base 674 of the support structure can be pinned to the interior surface 672 in either a fixed position 673, or alternatively moved to a secure position or alignment 675.

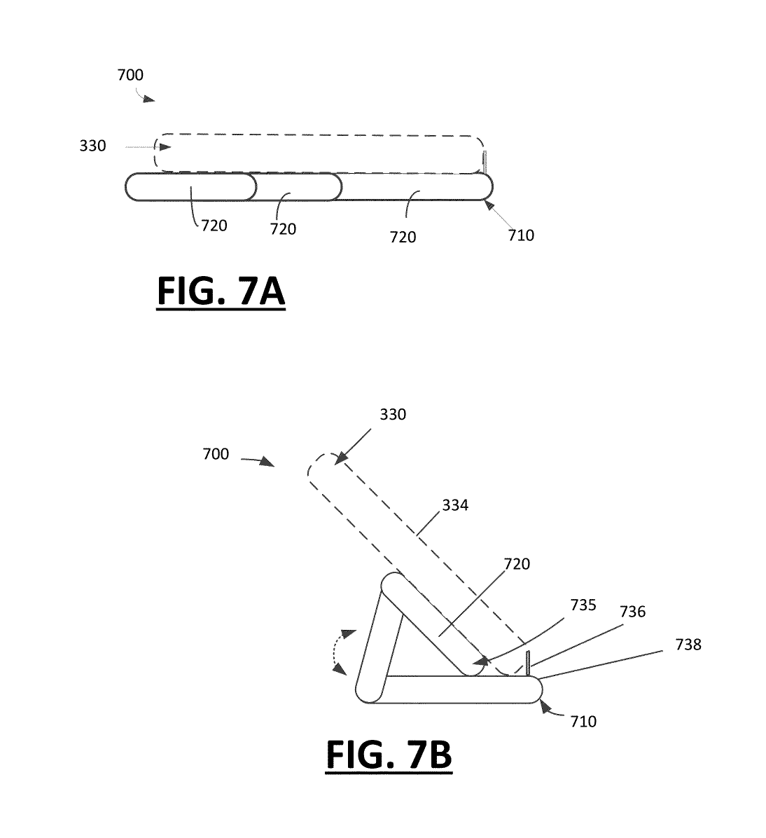

FIG. 7A and FIG. 7B show another example of a floatation accessory device in which a floatation structure is provided as part of an enclosure for an e-reading device, according to a variation. More specifically, a variation of FIG. 7A and FIG. 7B provides for a floatation accessory device 710 which includes multiple segments 720 that can be arranged in multiple orientations in order to provide a combined assembly in which the e-reading device 330 is supported in a partially upright position.

In more detail, the floatation accessory device 710 is shown to include three segments, each of which are pivotally connected to one another. One or more of the segments 720 can provide sufficient buoyancy to render the combined device 700 neutrally or positively buoyant. In variations, more or fewer segments 720 can be provided. Moreover, while in an example of FIG. 7A and FIG. 7B, the segments 720 are aligned to extend the length of the device, in variations the segments 720 can extend the width.

With reference to FIG. 7B, the segments 720 can be manipulated to create a base. In FIG. 7B, for example, the middle segment 720 is pivoted about 90 degrees, and the front most segment 720 is pivoted about 45 degrees, creating a base 735 and ledge 738 on which the e-reading device 330 can rest. A support lip 736 can be integrated with the bottom most segment 720 to retain the bottom surface of the e-reading device 330. When in the partially upright position, the front face 334 is acutely positioned with respect to the vertical to enable reading or viewing by the user.

In an example of FIG. 7B, the floatation accessory device 710 can include multiple segments which are buoyant, but primary buoyancy can be provided with the bottom most segment which is partially submerged when the other segments are manipulated to form the base. Thus, for example, the bottom most segment can be formed from a more buoyant cross-section than other segments.

In variations, the floatation accessory device 710 can be provided in other configurations or with other components. For example, the floatation accessory device 710 can be provided with a second segment to form an enclosure, or with a hinge to enable the device 710 to pivot from front to back of the e-reading device.

While the particular embodiment of FIGS. 7A-B are considered particularly beneficial, other specific structures or approaches may be employed to provide similar intended results for adjustability between relatively flat, collapsed, or recessed configurations, and angled configurations, for such a buoyant computing device assembly, and without departing from and in fact falling within the broad scope herein contemplated by this disclosure. For example, multiple specific approaches may be provided by a linked or otherwise cooperating articulating members in order to achieve similar results as provided in the embodiment of FIGS. 7A-B. In another example, all segments 532, 534, and 536 may be buoyant, or potentially one or more segments may not contribute buoyancy but still retain its intended functional characteristics and operational role in adjusting and supporting the e-reading device 330 in its respective collapsed and/or angled configurations. For illustration, in one specific such example, segment 532 may be buoyant, while one or both of segments 534 and 536 may be relatively less or non-buoyant, and still provide for the results of adjustability between collapsed and angled configurations shown in FIGS. 7A-B, and still supporting a e-reading device 330 in the angled configuration shown in FIG. 7B while floating in water.

As provided with any example described herein, including with examples of FIGS. 3A-B, FIGS. 4A-D, FIGS. 5A-C, FIG. 6 and FIG. 7A-B, various accessory devices are illustrated in which each is formed from a floatation structure having a buoyancy for causing a buoyancy of a combined device to be neutral or positive. According to some embodiments, the floatation structure of the individual embodiments, as described comprise a shell exterior and low density filler within the shell. By way of example, in one implementation, the exterior of a floatation structure can be formed from molded plastic, and an interior of the shell can be formed from air or foam.

Still further, with any of examples described, a dimension of accessory devices as shown and described by the various examples may be based on the dimensions of the e-reading device. In one implementation, each of a length or width of any cover floatation structure is within 20% of the dimension of the e-reading device, and more specifically within 5% of the dimension.

Although illustrative embodiments have been described in detail herein with reference to the accompanying Figures, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments—including such combinations that may not be specifically described or shown herein, as apparent to one of ordinary skill based on the totality of this disclosure. Thus, absence of describing such specific combinations does not preclude such combinations from the intended scope that may be claimed herein, either specifically for such combination or as included within a broader scope intended to cover such combination among other possible embodiments.

What is claimed is:

1. An accessory device for a computing device, the accessory device comprising:
a floatation structure;
a coupling mechanism to couple the floatation structure to the computing device, the coupling mechanism maintaining the floatation structure coupled to the computing device in at least a partially submerged water environment and in a non-submerged water environment,
wherein the floatation structure is dimensioned to cover at least a portion of the computing device when coupled to the computing device in the non-submerged environment; and
wherein the floatation structure includes a volume and weight that is sufficient to render a combined buoyancy of the accessory device coupled to the computing device to be at least neutral in water.

2. The accessory device of claim 1, wherein the volume and weight is sufficient to render the combined buoyancy of the accessory device coupled to the computing device to be positive in water.

3. The accessory device of claim 1, wherein the floatation structure includes a cover that overlays one of a front face or back face of the computing device.

4. The accessory device of claim 3, wherein the coupling mechanism is structured to enable the cover to move from overlaying one of the front face or back face to another of the front or back face.

5. The accessory device of claim 3, further comprising a structure provided with the cover to lift or tilt the computing device from a substantially planar orientation to an acute orientation relative to an interior of the cover, wherein in the acute orientation, a display provided on the front face is viewable at an angle of the acute orientation.

6. The accessory device of claim 3, wherein the coupling mechanism includes one or more straps that binds the cover to one of the front or back face of the computing device.

7. The accessory device of claim 3, wherein the coupling mechanism is structured to enable the cover to move from overlaying one of the front face or back face to another of the front or back face.

8. The accessory device of claim 1, wherein the accessory device includes a front cover and a back cover, the front cover and back cover being connected by an interconnecting structure, at least one of the front cover or back cover providing the floatation structure.

9. The accessory device of claim 8, wherein only one of the front or back cover has positive buoyancy to provide the floatation structure.

10. The accessory device of claim 9, wherein the front cover is the floatation structure, so that the combined buoyancy is positive when the front cover is within the submerged water environment.

11. The accessory device of claim 8, wherein the front cover includes an opening or window to expose a display screen on a front face of the computing device when the front cover overlays the front face.

12. The accessory device of claim 8, wherein the front cover and back cover are structured to have an appearance of a book jacket.

13. The accessory device of claim 8, wherein at least one of the front cover and back cover include a usability feature corresponding to one of a pocket, water proofed pocket, or mirror.

14. The accessory device of claim 8, wherein the front cover is pivotable to move to a wrapped orientation in which an outer surface of the front cover abuts an outer surface of the back cover.

15. The accessory device of claim 14, further comprising a structure provided with the cover to lift or tilt the computing device from a substantially planar orientation to an acute orientation relative to an interior of the back cover, wherein in the acute orientation, a display provided on the front face is viewable at an angle of the acute orientation.

16. The accessory device of claim 1, wherein the coupling structure includes a receptacle to receive and retain a thickness of the computing device.

17. The accessory device of claim 1, wherein the floatation structure is provided as a cover for the computing device, wherein the cover is:
positionable to overlay the front face at least when coupled to the computing device in the non-submerged water environment; and
pivotable to underlay the back face of the computing device when coupled to the computing device in the submerged water environment, the floatation structure being at least partially submerged when underlying the back in the submerged water environment.

18. The accessory device of claim 17, wherein the float structure is segmented into a plurality of segments, the plurality of segments being positionable to provide multiple orientations, including one or more orientations in which a segment of the float structure supports the computing device an a partially upright position.

19. A computing assembly comprising:
a computing device comprising a touch-sensitive display screen, the computing device being structured to be water resistant; and
a floatation accessory device that is coupleable to the computing device.

20. A computing device comprising:
a housing;
a display screen;
one or more internal components;
wherein the housing and display screen are at least water resistant to protect the one or more internal components from water; and
a floatation structure provided with the housing, the computing device with the floatation structure being at least neutrally buoyant.
